(19) United States
(12) Patent Application Publication
(10) Pub. No.: US 2009/0267759 A1
(43) Pub. Date: Oct. 29, 2009

(54) METHOD FOR CONTROLLING A WIRELESS SMART DISPLAY PANEL

(75) Inventors: Shey-Shy LU, Taipei (TW); Yu-Jie Huang, Taipei (TW); Tse-Yuan Chen, Taipei (TW); Shun-Yang Ko, Taipei (TW)

Correspondence Address: VENABLE LLP, P.O. BOX 34385, WASHINGTON, DC, 20043-9998, US

(73) Assignee: NATIONAL TAIWAN UNIVERSITY, Taipei (TW)

(21) Appl. No.: 12/182,902

(22) Filed: Jul. 30, 2008

(30) Foreign Application Priority Data
Apr. 25, 2008 (TW) 097115232

(51) Int. Cl. H04Q 7/00

(52) U.S. Cl. 340/539.22

(57) ABSTRACT

A method for controlling a wireless smart display panel. The method uses a sensor to monitor environmental information, such as temperature or humidity, and the information is transmitted to a processor by using a wireless communication device that is compatible with IEEE 802.15.4. Moreover, the environmental information is converted to image information and displayed on a display device through the processor. Consequently, users understand outward environmental information in time.

### FIELD OF THE INVENTION

The invention relates to a method for controlling a wireless smart display panel, and more particularly, to a method for displaying environmental information by processing the detected environmental information through wireless transferring devices and processors.

### BACKGROUND OF THE INVENTION

With the natural environment and climate changing quickly, weather prediction may not always correspond to the current condition and even may cause people to feel uncomfortable because of unsuitable clothing. If people can prepare well before going outdoors by watching outdoor environmental information via a smart device, it will be helpful to facilitate life quality.

Almost all display devices in our life are controlled and adjusted by a software inside the devices to show images. For example, a rainbow clock can change its color by a specific calculated rule or special software to change its back screen color. However, these display devices cannot react and adapt to the change of the environmental information in time.

Some of the smart device uses infrared rays or Bluetooth to transfer environmental information. However, the infrared ray transmission shortcomings, such as limitation in the transmission direction, easy to be cut off, slow transmission rate and high power consumption, with respect to Bluetooth transmission limits the market choice in choosing signal transmission carrier especially in short distance transmission. Although the current consumption of Bluetooth is lower than that of infrared rays, but it still has the value higher than 100 μA.

### SUMMARY OF THE INVENTION

The main objective of the present invention is to provide a method for controlling a wireless smart display panel.

The wireless communication of the present invention is compatible with IEEE 802.15.4, a type of short distance communication, with advantages of low transmission speed, lost cost, low power consumption and simple, and is especially available for specific restrictions such as cost and power consumption.

The properties of IEEE 802.15.4 are shown on Table. 1 where different wireless transmission methods are shown. When the same electricity is applied to the IEEE 802.15.4, GSM/GPRS, Wi-Fi or Bluetooth, the battery's life cycle of IEEE 802.15.4 in transmission is longer than those of others listed in table 1. Therefore, IEEE 802.15.4 is efficient in power-saving.

TABLE 1

| | IEEE | | | |
|---|---|---|---|---|
| | 802.15.4 | GSM/GPRS | Wi-Fi | Bluetooth |
| system resources | 4 KB-32 KB | 16 MB+ | 1 MB+ | 250 KB+ |
| battery life(days) | 100-1000+ | 1-7 | 0.5-5 | 1-7 |
| Network size | unlimited(2⁶⁺) | 1 | 32 | 7 |
| Bandwidth (KB/s) | 20-250 | 64-128+ | 11000+ | 720 |
| Transmission range | 1-100+ | 1000+ | 1-100 | 1-10+ |
| (meters) | | | | |

The method of the present invention uses a sensor to sense the environmental information, such as temperature or humidity, and to transmit the information to a processor or a control circuit by using wireless communication. Moreover, environmental information is converted to image information and displayed on the display device through the processor or the control circuit. Therefore, users could get outdoor environmental information in time.

Accordingly, the present invention provides a method for controlling wireless smart display panel by a processor and comprises steps as following:

(100) sensing environmental information by the sensor of the sensor module;

(200) transferring the environmental information to the second wireless transmission unit via the first wireless transmission unit; and

(300) transferring the environmental information to the processor and then converting into an image information, and the processor further comprising a database;

(400) displaying the image information on the display device.

The method of the present invention may also be controlled by a control circuit and comprises steps as following:

(500) detecting environmental information by a sensor of a sensor module;

(600) transferring the environmental information to a second wireless transmission unit through a first wireless transmission unit; and

(700) transferring the environmental information to a control circuit; and

(800) the control circuit is programmed logically to enable the illuminating device mixing colors of RGB.

### BRIEF DESCRIPTION OF THE DRAWINGS

Many of the attendant advantages and features of this invention will become more apparent by making references to the following detailed description, when taken in conjunction with the accompanying drawings, wherein:

FIG. 1 is a scheme of the first wireless-controlled display panel in accordance with the present invention.

FIG. 2 is a flow chart of the method (10) in accordance with the present invention.

FIG. 3 is a detail flow chart of the step (400) in accordance with the present invention.

FIG. 4 is a scheme of the second wireless-controlled display panel in accordance with the present invention.

FIG. 5 is a flow chart of the method (20) in accordance with the present invention.

FIG. 6 is the temperature and humidity sensor in accordance with the present invention.

FIG. 7 is a first wireless transmission unit in accordance with the present invention.

FIG. 8 is a sensor module in accordance with the present invention.

FIG. 9 is a second wireless transmission unit in accordance with the present invention.

FIG. 10 is a micro-control-unit (MCU) in accordance with the present invention.

### DETAILED DESCRIPTION OF THE PRESENT INVENTION

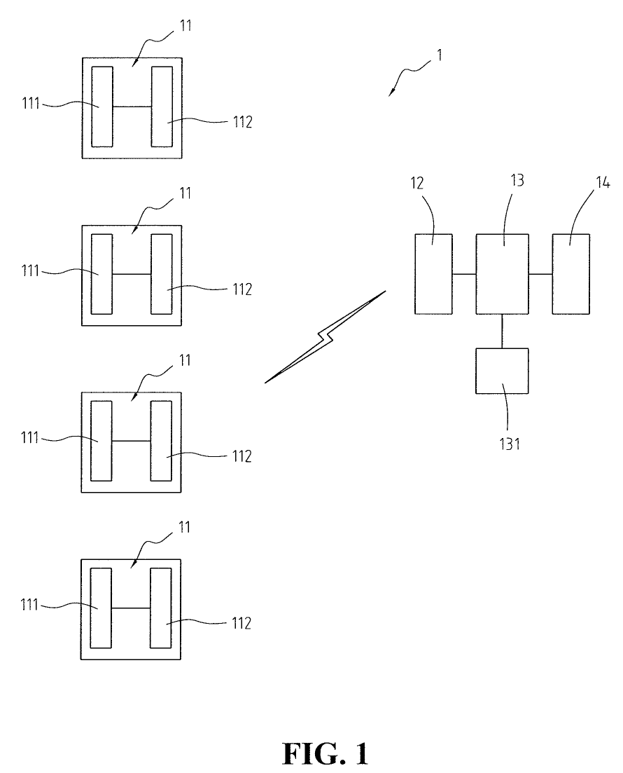

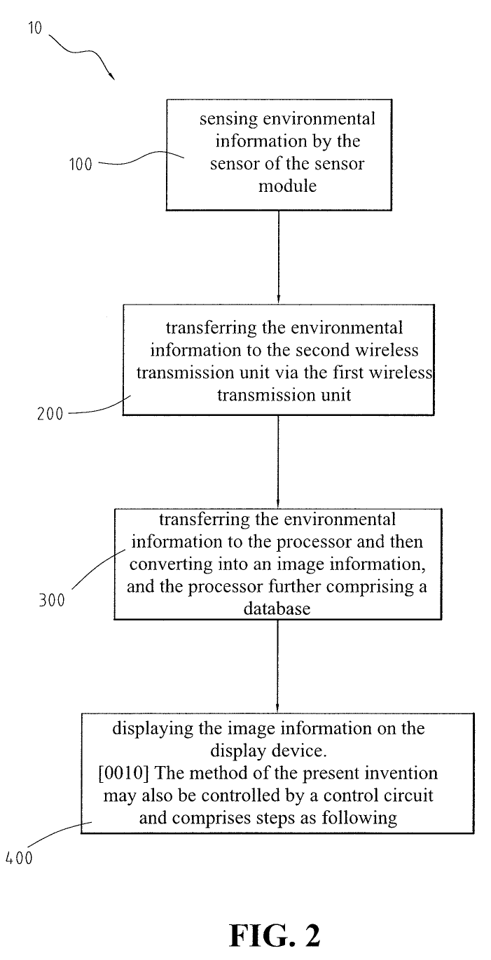

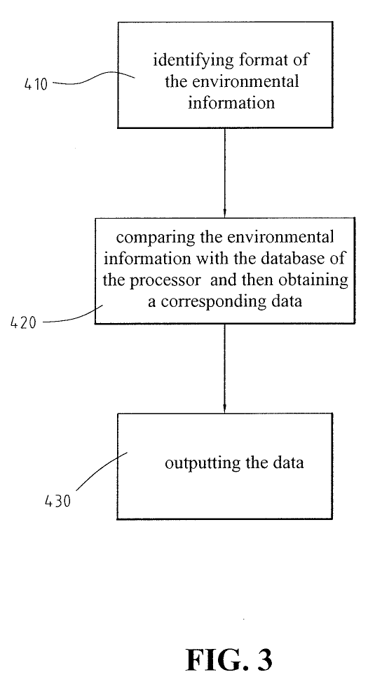

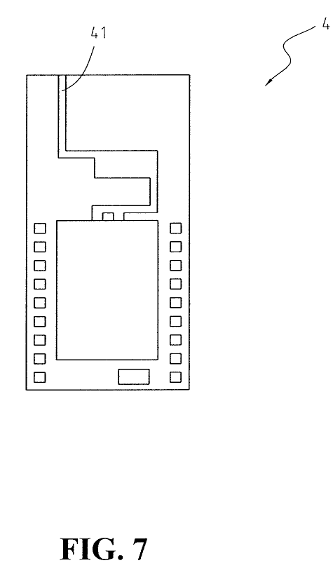

With reference to FIGS. 1-3 and 7, an embodiment of the present invention illustrates a method (10) for controlling wireless smart display panel by using a first wireless-controlled display panel (1). The first wireless-controlled display panel (1) comprises:

at least one sensor module (11) having a sensor (111) and a first wireless transmission unit (112) electrically connected to the sensor (111), the sensor (111) is used to detect environmental information. The sensor (111) is a temperature and humidity sensor (3), manufactured by SENSIRION Co. The temperature and humidity sensor (3) has a humidity sensing unit (31), a temperature sensing unit (32) and a memory (33). The sensor module (11) detects temperature and humidity information by connecting to the temperature and humidity sensor (3). Besides, the sensor (111) can also be used to detect brightness, or concentration of nitrogen and carbon dioxide in different applications. The function of the wireless transmission unit (112) is substantially the same as the EasyBee (4) of FlexiPanel Co. which is a ZigBee (4) module to transmit and receive signals via an embedded internal antenna. Besides, devices which are compatible with IEEE 802.15.4 protocol can used in the present invention;

a second wireless transmission unit (12) is coupled to the wireless transmission unit (112) and electrically connected to a processor (13). The processor (13) may be a computer, a system-on-a-chip (SOC) microcontroller or a system-on-package (SOP) and further comprise a database having therein previous stored pictures or images for comparing with environmental information and then converting environmental information into image information. In addition, the processor (13) connects to an Internet (131) for sending image information away; and

a display device (14) can be used as a liquid crystal display or an organic light emitting diode (OLED) panel, and the display device (14) is coupled to the processor (13).

The method (10) comprises steps as following:

(100) sensing environmental information by the sensor (111) of the sensor module (11);

(200) transferring the environmental information to the second wireless transmission unit (12) via the first wireless transmission unit (112); and

(300) transferring the environmental information to the processor (13) and then converting into an image information, and the processor (13) further comprises a database; and

(400) displaying the image information on the display device (14).

The step (400) further comprises the following steps:

(410) identifying format of the environmental information;

(420) comparing the environmental information with the database of the processor and then obtaining a corresponding data; and

(430) outputting the data.

Consequently, users will have outdoor temperature and humidity information in time through the images or pictures shown on the display device (14) for choosing suitable dress or accessories.

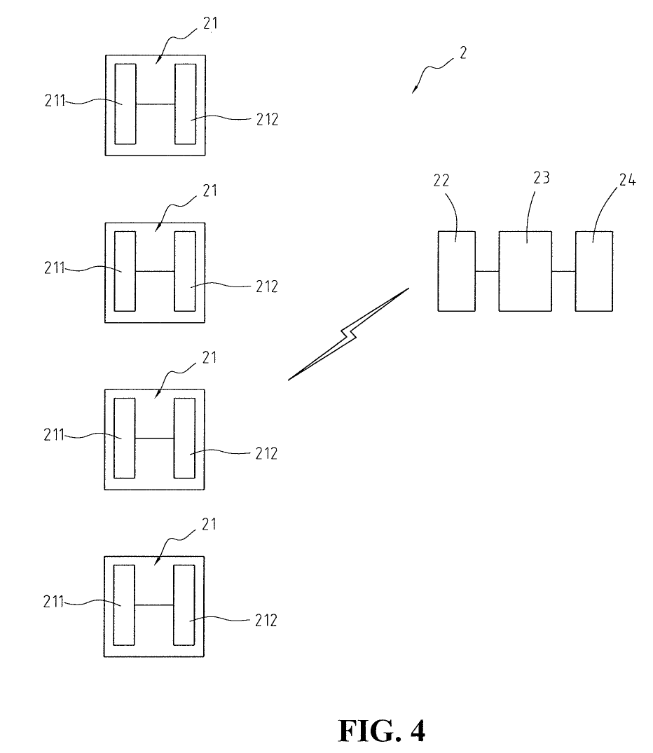

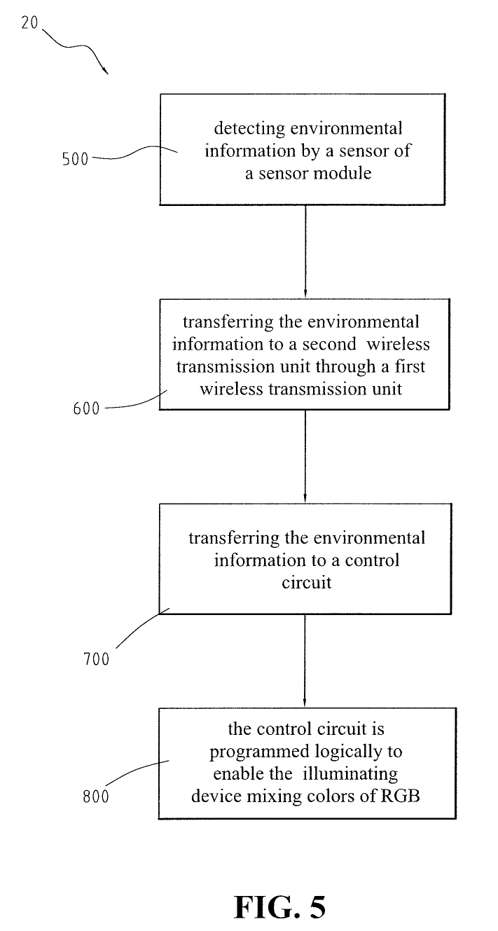

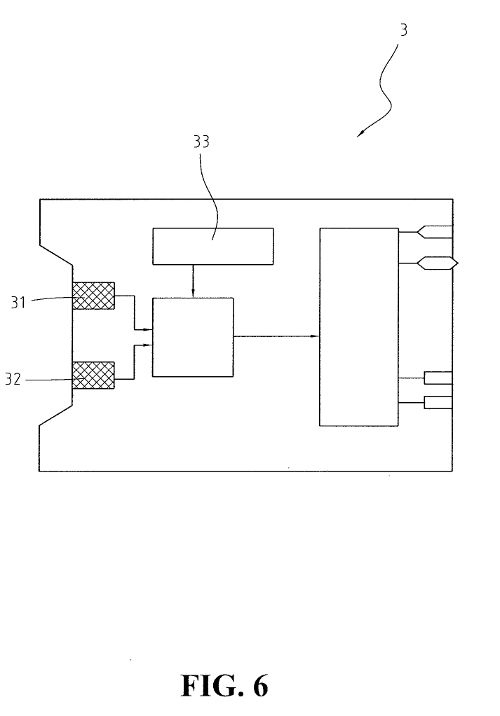

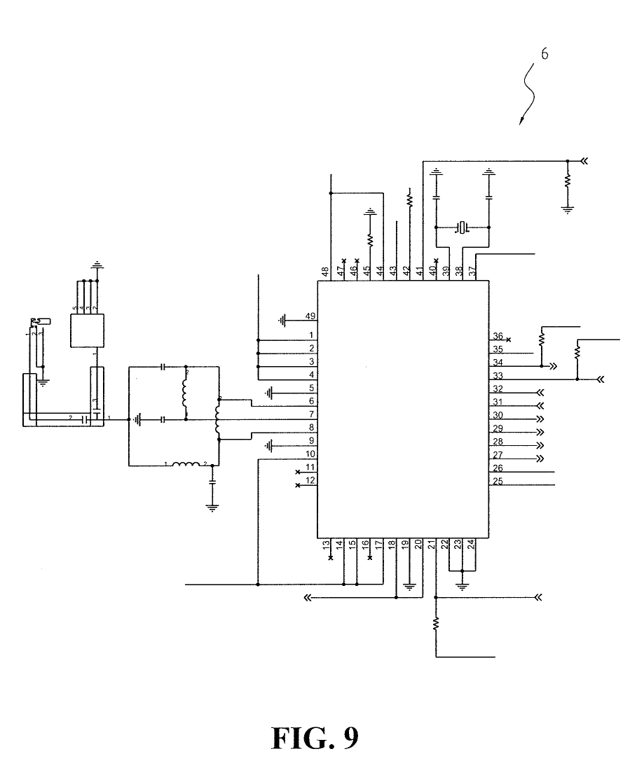

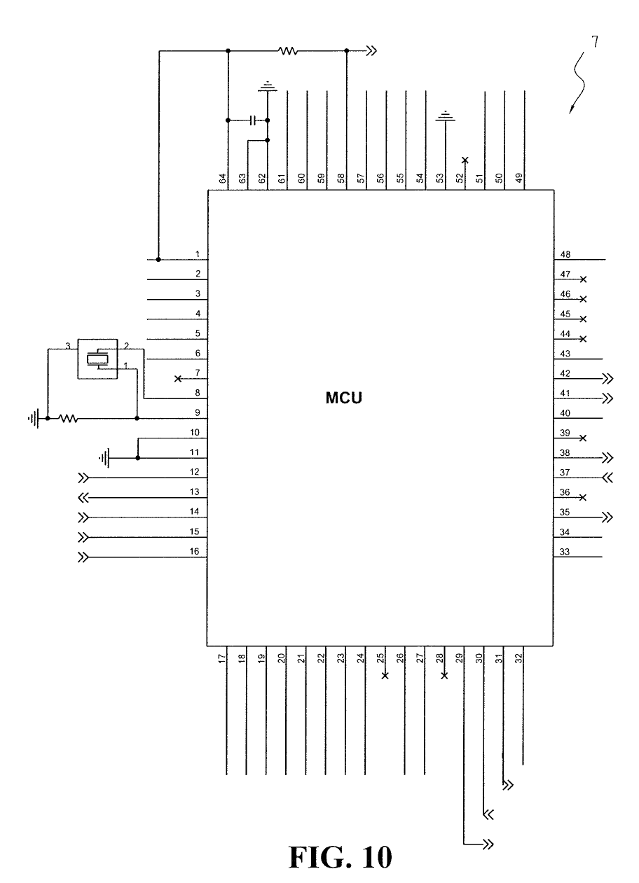

Besides, with reference to FIGS. 4-6 and 9-10, another embodiment of a method (20) for controlling wireless smart display panel by using a second wireless-controlled display panel (2) is shown. The second wireless-controlled display panel (2) comprises:

at least one sensor module (21) including a sensor (211) and a first wireless transmission unit (212). The sensor (211) is electrically connected to the first wireless transmission unit (212) and used to detect environmental information. The sensor (211) in this embodiment is a temperature and humidity sensor (SHT1X) (3) manufactured by such as SENSIRION Co. Also, the sensor (211) can also be used to detect brightness, or concentration of nitrogen and carbon dioxide in different applications. The wireless transmission unit (212) is an EasyBee (4) of FlexiPanel Co. which is a ZigBee (4) module to transmit and receive signals via an embedded antenna. Besides, devices compatible with IEEE 802.15.4 protocol can also be used in the present invention;

a second wireless transmission unit (22) which is coupled to the wireless transmission unit (212) and electrically connected to a control circuit (23). The second wireless transmission unit (22) is a CC2420 chip manufactured by such as Texas Instruments Co. which is a ZigBee compatible with IEEE 802.15.4 protocol with lower power consumption. The control circuit (23) is constructed in a microcontroller (7) and programmed logically; and

an illuminating device (24), may be a light emitting diode (LED) or an organic light emitting diode (OLED) device, which is electrically connected to the control circuit (23).

The method (20) comprises steps as fellow:

(500) detecting environmental information by a sensor (211) of a sensor module (21);

(600) transferring the environmental information to a second wireless transmission unit (22) through a first wireless transmission unit (212); and

(700) transferring the environmental information to a control circuit (23); and

(800) the control circuit (23) is programmed logically to enable an illuminating device (24) mixing colors of RGB.

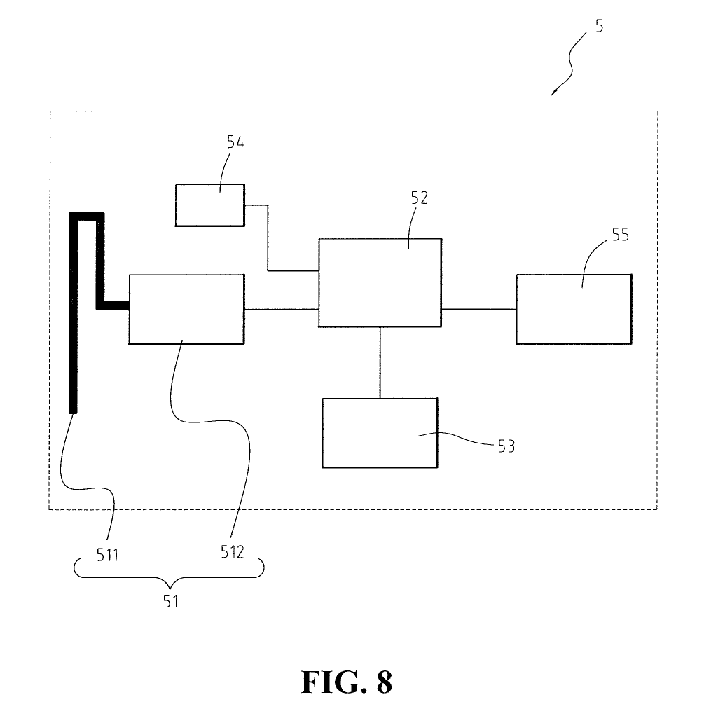

With reference to FIG. 8, a TAROKO or Telos platform (5) could be alternatively used in the sensor module (11, 21). The TAROKO platform (5) comprises a Radio Frequency (RF) module (51), a micro-control unit (MCU) (52), a sensor element (53), a data register (54) and a USB port (55). The RF module (51) is compatible with IEEE 802.15.4 protocol and comprises an antenna (511) and a wireless transmission unit (512). The wireless transmission unit (512) is a CC2420 chip manufactured by Texas Instruments Co. The sensor element (53) is a temperature, humidity or photo sensor.

To sum up, in order to lower power consumption, the method of present invention is limited operated with IEEE 802.15.4 to provide users getting outward environmental information in time.

Even though the invention has been particularly shown and described with reference to preferred embodiments, these are merely examples to help make the invention more easily understandable and are not intended to limit the invention. That various changes, modifications, and alterations in form and details may be made therein without departing from the spirit and scope of the invention, as set forth in the following claims will be understood by those skilled in the art.

1. A method for controlling a wireless smart display panel comprising:
(100) sensing environmental information by a sensor of a sensor module;
(200) transferring the environmental information to a second wireless transmission unit via the a first wireless transmission unit;
(300) transferring the environmental information to a processor and then converting into an image information, with the processor further comprising a database; and
(400) displaying the image information on a display device.

2. The method as claimed in claim 1, wherein the first or second wireless transmission unit is a ZigBee.

3. The method as claimed in claim 1 or 2, wherein the processor is a computer.

4. The method as claimed in claim 1 or 2, wherein the processor is a system-on-a-chip (SOC) or system-on-package (SOP).

5. The method as claimed in claim 1, wherein the step (400) further comprising:
(410) identifying a format of the environmental information;
(420) comparing the environmental information with the database of the processor and then obtaining a corresponding data; and
(430) outputting the data.

6. The method as claimed in claim 1 or 2, wherein the display device is a liquid crystal display device.

7. The method as claimed in claim 1 or 2, wherein the display device is an organic light emitting diode (OLED) panel.

8. The method as claimed in claim 1 or 2, wherein the sensor module is a temperature sensor module.

9. The method as claimed in claim 1 or 2, wherein the sensor module is a humidity sensor module.

10. The method as claimed in claim 1 or 2, wherein the sensor module is an ultraviolet (UV) ray sensor module.

11. The method as claimed in claim 1 or 2, wherein the sensor module is a nitrogen sensor module.

12. The method as claimed in claim 1 or 2, wherein the sensor module is a carbon dioxide sensor module.

13. The method as claimed in claim 1 or 2, wherein the image information is connected to Internet through the processor.

14. A method for controlling a wireless smart display panel comprising:
(500) detecting environmental information by a sensor of a sensor module;
(600) transferring the environmental information to a second wireless transmission unit through a first wireless transmission unit; and
(700) transferring the environmental information to a control circuit, wherein
(800) the control circuit is programmed logically to enable an illuminating device to mix colors of RGB.

15. The method as claimed in claim 14, wherein the first or second wireless transmission unit is a ZigBee.

16. The method as claimed in claim 14 or 15, wherein the display device is a light emitting diode (LED) or an organic light emitting diode (OLED).

17. The method as claimed in claim 14 or 15, wherein the sensor module is a temperature sensor module.

18. The method as claimed in claim 14 or 15, wherein the sensor module is a humidity sensor module.

19. The method as claimed in claim 14 or 15, wherein the sensor module is an ultraviolet (UV) ray sensor module.

20. The method as claimed in claim 14 or 15, wherein the sensor module is a nitrogen sensor module.

21. The method as claimed in claim 14 or 15, wherein the sensor module is a carbon dioxide sensor module.

22. The method as claimed in claim 14 or 15, wherein the sensor module is a biosensor module
